(19) United States
(12) Patent Application Publication
(10) Pub. No.: US 2017/0355379 A1
(43) Pub. Date: Dec. 14, 2017

(54) DRIVING SUPPORT DEVICE

(71) Applicant: DENSO CORPORATION, Kariya-city (JP)

(72) Inventors: Kenichi HAMAGUCHI, Kariya-city (JP); Kiyotaka TAGUCHI, Kariya-city (JP)

(21) Appl. No.: 15/615,936

(22) Filed: Jun. 7, 2017

(30) Foreign Application Priority Data
Jun. 9, 2016 (JP) 2016-115313

(51) Int. Cl. B60W 40/09; G08B 21/06; B60K 28/06; G06K 9/00

(52) U.S. Cl. CPC B60W 40/09; G06K 9/00845; G08B 21/06; B60K 28/066

(57) ABSTRACT

A driving support device for a vehicle includes: a detector that detects a driving condition of a driver; a memory that stores a proper driving condition of the driver; and a controller that compares a detected driving condition with the proper driving condition stored in the memory, calculates a difference between the detected driving condition and the proper driving condition, and executes a notification operation to the driver according to the difference when the controller recognizes the difference. The controller executes the notification operation to facilitate a recovery to the proper driving condition. Thus, the driving support device reduces uncomfortable feeling of the driver when the controller executes the notification operation.

### CROSS REFERENCE TO RELATED APPLICATION

This application is based on Japanese Patent Application No. 2016-115313 filed on Jun. 9, 2016, the disclosure of which is incorporated herein by reference.

### TECHNICAL FIELD

The present disclosure relates to a driving support device.

### BACKGROUND

Conventionally, a system detects a condition of a driver of a vehicle when the driver drives the vehicle using various sensors, and gives a warning and/or suggests an improvement of a driving condition to the driver when the condition of the driver is out of a proper condition. In this case, information from various vehicular sensors, information from a peripheral image shooting camera, navigation information and information about a driving period are collected, and based on the information, the driving condition of the driver is estimated at each item such as an inattentive driving, a loosely driving, a sleepily driving and a tiredly driving. When the estimated driving condition is outside of the proper driving condition, and it is determined that it is necessary to give the warning and the proposal to the driver, the system informs of the driver through a display of a phrase, a display of a motion picture and/or a output of a voice message.

However, in view of the following points, the above system is not always appropriate for the driver when the system gives the warning and the suggestion.

For example, when the driver frequently checks around the vehicle, the system may determine with high frequency that the driver drives the vehicle inattentively, and therefore, the system gives the driver the warning. Thus, the warning may bother the driver since the driver receives the unwanted warning.

Further, when the vehicle runs on an express way, the driver feels drowsy slightly. In this case, the system may determine with high frequency that the driver drives the vehicle with drowsiness, and the system suggests a break at each time. Thus, the suggestion may bother the driver.

Patent Literature No. 1: JP-2007-61484

Patent Literature No. 2: JP-2009-244986

### SUMMARY

It is an object of the present disclosure to provide a driving support device for warning and suggesting appropriately in accordance with the driver condition,

According to an aspect of the present disclosure, a driving support device for a vehicle includes: a detector that detects a driving condition of a driver; a memory that stores a proper driving condition of the driver; and a controller that compares a detected driving condition with the proper driving condition stored in the memory, calculates a difference between the detected driving condition and the proper driving condition, and executes a notification operation to the driver according to the difference when the controller recognizes the difference.

In the above driving support device, the controller recognizes the difference when a level of the detected driving condition is higher or lower by a predetermined value than a level of the proper driving condition. Further, the controller executes the notification operation to facilitate a recovery to the proper driving condition. Thus, the driving support device reduces uncomfortable feeling of the driver when the controller executes the notification operation.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an electric system according to a first embodiment;

FIG. 2 is a diagram showing an arrangement in a compartment of a vehicle;

FIG. 3 is a flowchart showing a determination process program;

FIG. 4 is a diagram showing a functional explanation view;

FIG. 5 is a diagram showing a data structure of a database for a proper driving condition;

FIG. 6 is a diagram showing a standard level of a proper condition of each item at each driving situation;

FIGS. 7A and 7B are diagrams showing different check range of drivers at an express way; and

FIG. 8 is a diagram showing a check range of a driver at an intersection.

### DETAILED DESCRIPTION

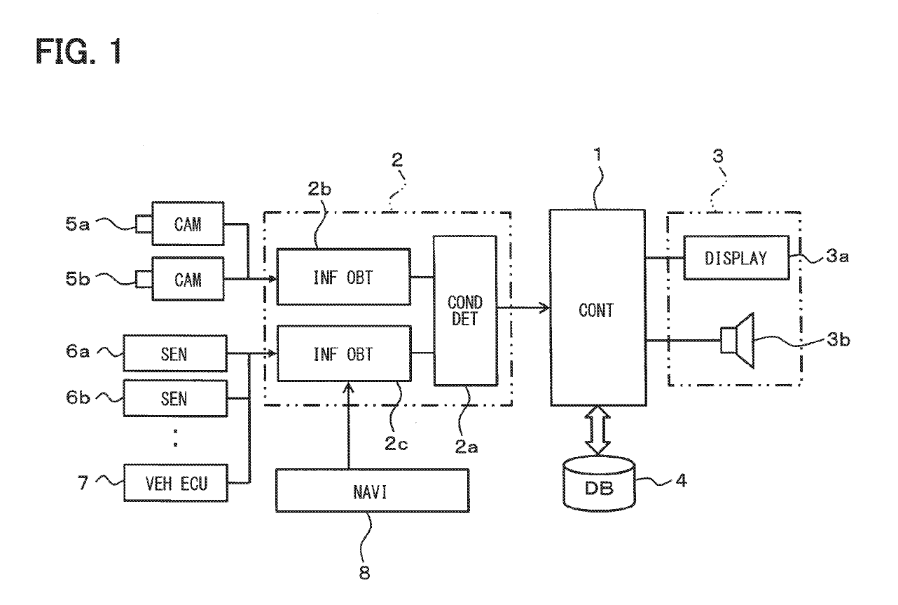

The present disclosure will be explained with reference to FIGS. 1 to 3. As shown in FIG. 1, a controller 1 for controlling a whole of a driving support device includes a microcomputer, a memory, an interface and the like. A determination program is stored in the controller 1. The controller 1 is connected to a condition detector 2 and a notification unit 3. Further, the controller 1 is connected to a database 4 as a memory.

The condition detector 2 includes a condition detection device 2a and an information obtaining units 2b, 2c. Image signals from a camera 5a for shooting an inside of a compartment and a camera 5b for shooting an outside of the vehicle are input into the information obtaining unit 2b. The information obtaining unit 2c is connected to various sensors 6a, 6b for detecting a condition of the driver, a ECU 7 of the vehicle for outputting vehicular information indicative of the driving condition of the vehicle, and a vehicular navigation device 8 for outputting navigation information. The condition detecting device 2a estimates and evaluates the driver condition based on the information input from the information obtaining units 2b, 2c, and outputs the estimated driver condition as an estimation condition Yn toward the controller 1.

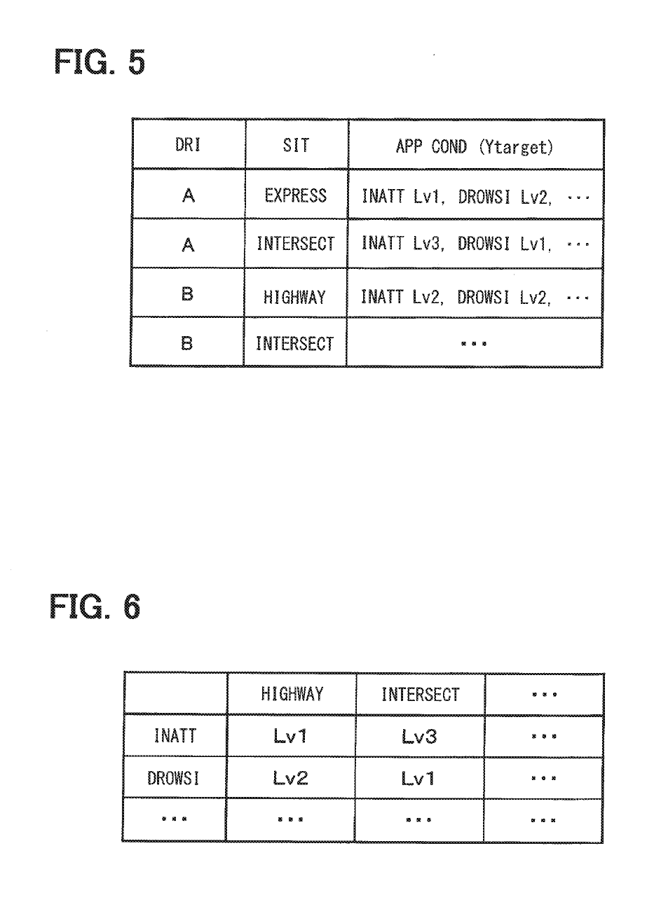

The notification device 3 includes a display 3a and a voice output device 3b such as a speaker. The notification device 3 provides the notification information from the controller 1 as the display information and the voice information to the driver. The database 4 stores the appropriate condition Ytarget indicative of the level of the appropriate driving condition with respect to the driver who drives the vehicle. In this case, the appropriate condition Ytarget is stored for each driver and each situation, as shown in FIG. 5.

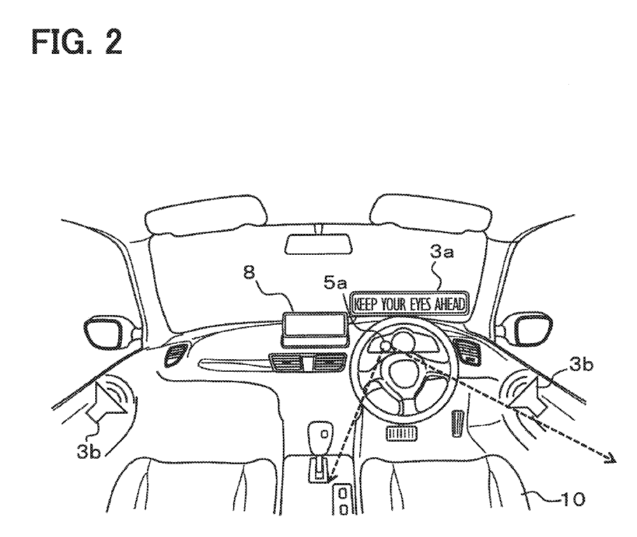

FIG. 2 shows an arrangement of the inside of the compartment of the vehicle. The camera 5a is arranged at a portion of a dashboard in front of a driver seat, for example. For example, the camera 5a shoots the driver of the driver seat 10 in a range between two dashed arrows in FIG. 2. The display 3a is arranged as a HUD (i.e., head up display) above the dashboard in front of the driver seat 10. Here, as described later, the display 3a displays the notification information for alerting the driver. The voice outputting device 3b such as the speaker is arranged at a door of both sides of the vehicle, for example. The display unit of the navigation device 8 is arranged at a center of the dashboard.

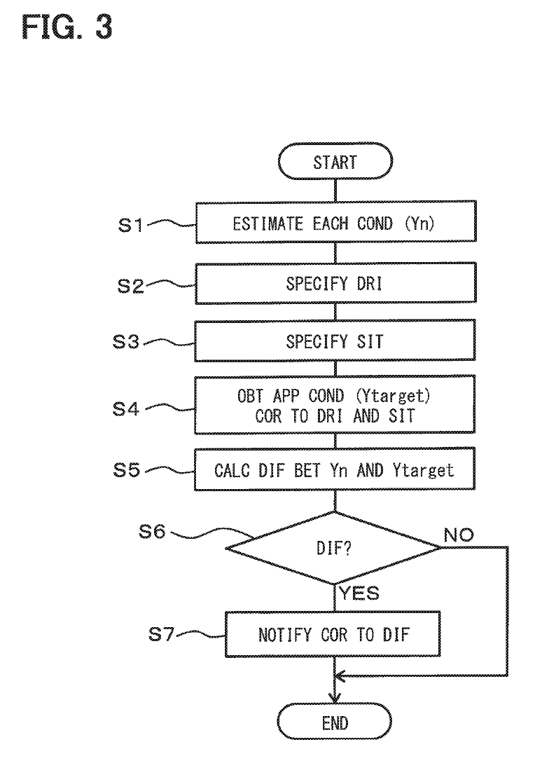

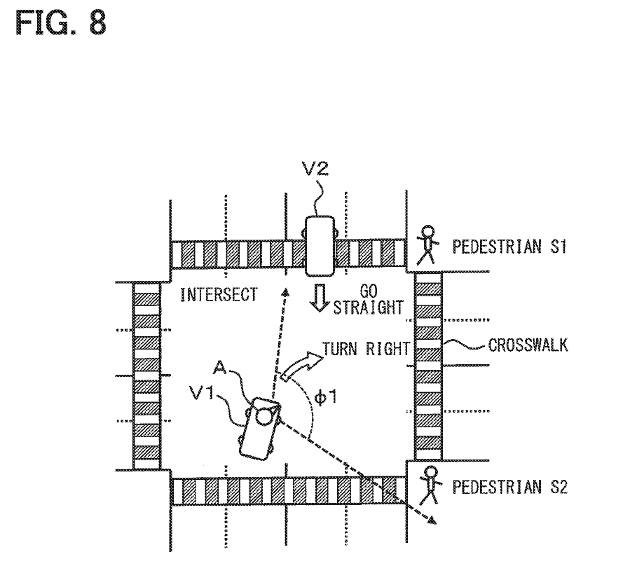

Next, the function of the above system will be explained with reference to FIGS. 3 to 8.

In the condition detector 2, the image of the driver shot by the camera 5a in the compartment and the image of the outside of the vehicle shot by the camera 5b outside of the vehicle are input into the condition detecting device 2a through the information obtaining unit 2b. Similarly, the detection signal from each sensor 6a, 6b for detecting the driver condition, the vehicular information input from the ECU 7 of the vehicle, and the navigation information input from the navigation device 8 are input into the condition detecting device 2a through the information obtaining device 2c. The condition detecting device 2a analyzes the driver condition and the driving situation based on the above information, and calculates the estimation condition Yn corresponding to the driving situation. Then, the device 2a outputs the estimation condition Yn to the controller 1. The estimation condition Yn, for example, includes various conditions such as the inattentive level and drowsiness level as an estimation object.

In the above case, a technique for detecting the driving condition of the driver is to estimate the driving condition based on a conventional image analysis technique and an analyzing procedure of the vehicular information. For example, the inattentive condition and the awareness condition are detected based on the image information. Further, the awareness level is determined based on the diving features characterized by the vehicular information and the like indicative of the driving operation status of the vehicle. The driving situation is determined by coupling with the map information using the navigation information so that the driving place and the situation are detected.

Next, the execution contents of the determination procedure program executed by the controller 1 will be explained under a condition that, for example, the driver A drives the vehicle V1. At step S1, the controller 1 estimates the estimation condition Yn corresponding to the driving condition of the driver A based on the information input from the condition detection device 2a. Next, at step S2, the controller 1 specifies the driver based on the image information from the camera 5a and various information. At step S3, the controller 1 specifies the situation of the driving condition based on the information from the navigation device 8.

Thus, the information about the estimation condition Yn of the driving condition is specified when the driver A drives the vehicle on the express way. At step S4, the controller 1 reads the appropriate condition Ytarget indicative of the level of the appropriate driving condition of the driver A on the express way from the database 4. Then, the controller 1 proceeds to step S5. At step S5, the controller 1 calculates the difference ΔY (=Ytarget−Yn) between the read-out appropriate condition Ytarget and the estimation condition Yn.

Then, when the difference ΔY is not equal to zero, i.e., when the difference as a calculation result arises, the controller 1 determines “YES” at step S6, and then, it goes to step S7. At step S7, the notification operation according to the difference is executed. When the difference ΔY is equal to zero, i.e., when the difference as a calculation result does not arise, the controller 1 determines “NO” at step S6, and then, the program is terminated.

In the above case, the calculation result at step S5 may include a case where the difference arises when the estimation condition is higher than the appropriate condition, and a case where the difference arises when the estimation condition is lower than the appropriate condition. In accordance with these cases, at step S7, the controller 1 prompts the driver to feel relaxed using the display operation and the voice/sound output when it is necessary to reduce the awareness level with respect to the appropriate level. The controller 1 awakens the driver using the display operation and the voice/sound output when it is necessary to increase the awareness level with respect to the appropriate level.

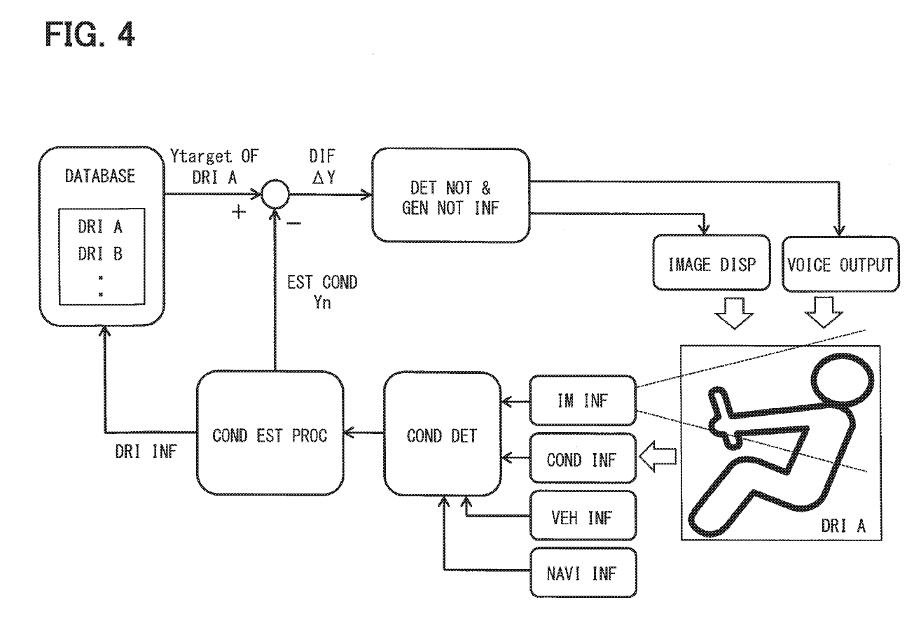

FIG. 4 shows the above operation as an example when the driver A drives the vehicle. The driving condition of the driver A is detected by the camera 5a, the sensors 6a, 6b and the like. Further, the driving condition and the driving situation of the driver A are also detected by the camera 5b, the vehicular information from the ECU 7, the navigation information from the navigation device 8 and the like.

When the driving condition of the driver A is detected, the driving condition is analyzed, so that the driver is specified and the estimation process of the driving condition is executed. Thus, the information about the driver A as driver information is requested to the database, so that the estimation condition Yn is output. The estimation condition Yn includes information about levels corresponding to various items. For example, the estimation condition Yn includes the inattentive level, the drowsiness level, and other levels.

The controller 1 calculates the difference ΔY (=Ytarget−Yn) between the estimation condition Yn corresponding to the driving condition of the driver A and the appropriate condition Ytarget indicative of the normal driving condition under the situation of the driver A. The controller 1 determines based on the difference ΔY whether the controller 1 outputs the notification to the driver A. When the difference ΔY is not equal to zero, i.e., when the level of the estimation condition Yn is higher or lower than the level of the appropriate condition Ytarget, the controller 1 generates the notification information.

According to the generated notification information, as shown in FIG. 2, for example, the display 3a displays the phrase “KEEP YOUR EYES AHEAD” so that the controller 1 alerts the driver A who feels drowsy or drives a vehicle inattentively. Further, the display 3a displays the phrase “GET RELAXED” or the like, so that the controller 1 reduces the tension of the driver in accordance with the excited state or the nerves state of the driver.

When the controller 1 outputs a sound or a voice message, the voice output device 3b outputs the voice message or music in order to apply stimulus in a case where the awareness level of the driver A is low, so that the controller 1 alerts the driver. Further, when the voice output device 3b outputs the calming sound or the relaxing music, the controller 1 makes the driver A in the excited state or the nerves state feel relaxed.

Next, the data of the proper condition in view of the above described determination process will be explained. The database 4 stores the data Ytarget indicative of the level of the proper condition of the driver A and the driver B. For example, as shown in FIG. 5, the data Ytarget indicative of the level of the proper condition is defined as a set of multiple items such as the inattentive level and the drowsiness level. Further, the data Ytarget includes multiple sets, each of which is defined by a respective driver A and B at a respective driving situation.

The above data reflects a feature such that each of the drivers A and B and others drives the vehicle in a different manner so that the proper condition of a standard driving way of each driver is also different. For example, FIG. 6 shows a driving condition of each of the driver A, the driver B at a high way.

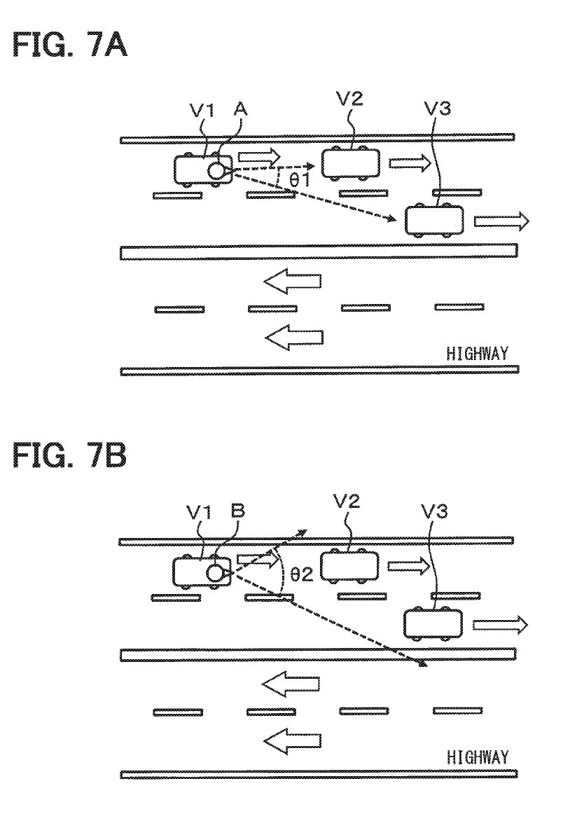

As shown in FIG. 7A, the driver A is an ordinary driver, and the visual range of the displacement of the visual line is about θ1 in an angle range when the driver A drives the vehicle on the highway, and the driver A displaces the visual line in a manner that the driver A has a visual contact with the vehicles V2, V3 in front of the subject vehicle V1. On the other hand, as shown in FIG. 7B, the driver B is a nervous driver so as to carefully and visually recognize the surroundings of the vehicle, and the visual range of the displacement of the visual line is about θ2 in an angle range even when the driver B drives the vehicle on the highway, and the driver B displaces the visual line in a manner that the driver B has a visual contact with a wide range including the vehicles V2, V3 in front of the subject vehicle V1. Here, the angle range θ2 is larger than the angle range θ1.

On the highway, the visual range of the displacement of the visual line of each driver is described above. In a different driving situation such as at an intersection, the condition is different. For example, as shown in FIG. 7, at the intersection, when the vehicle is a right-hand steering wheel car, and the vehicle turns right, the driver turns the visual line toward the vehicle V2 which comes in the opposition direction from the front side, and further turns the visual line toward a road ahead of the vehicle after the vehicle turns right. Furthermore, the driver turns the visual line toward the pedestrians S1, S2 who are to cross the street on a crosswalk on the road ahead of the vehicle after the vehicle turns right at the intersection. In this case, the visual range of the driver A, B is wider than the above situation on the highway, and the visual range of the displacement of the visual line is about φ1. The angle range φ1 is larger than the angle range θ2.

Thus, the visual ranges of the displacement of the visual line in a normal condition of different drivers are different. In this case, if the controller 1 executes the determination process of the inattentive driving under the same criteria for the drivers A, B, the controller 1 may determine that the driver A is in the proper condition and the driver B is out of the proper condition so that the driver B drives the vehicle inattentively even in a case where each of the drivers B displaces the visual line normally.

Further, the visual ranges of the displacement of the visual line at different driving situations are also different. For example, the visual range of the displacement of the visual line in a normal condition of each driver A, B at the intersection is different from the highway. In this case, if the controller 1 executes the determination process of the inattentive driving under the same criteria as the highway, the controller 1 may determine that each driver A, B drives the vehicle inattentively.

Further, the driving situation includes a factor of time in addition to a factor of a place. For example, when the road is defined as a school route, the proper condition within a commuting time zone is different from other time zone. Further, if a factor of navigation information is added, the proper condition at the same place under certain navigation information situation is set to be different from other situations. For example, when the traffic amount during an event is largely different from the traffic amount during other time, the proper condition during the event time is set to be different from other time.

The standard level of the proper condition in view of different drivers in the normal driving condition is stored at different situations including each place and each time zone in the database 4. As shown in FIG. 5, for example, the level of the inattentive driving on the highway for the driver A is defined as Lv1, and the level of the drowsiness state on the highway for the driver A is defined as Lv2. The level of the inattentive driving at the intersection for the driver A is defined as Lv3, and the level of the drowsiness state at the intersection for the driver A is defined as Lv1. The level of the inattentive driving on the highway for the driver B is defined as Lv2, and the level of the drowsiness state on the highway for the driver B is defined as Lv2.

The data of each level of the proper condition at different situations and different drivers stored in the database 4 may be preliminarily set or input by the driver or an operator other than the driver as the proper condition. Alternatively, the data of the standard proper condition may be preliminarily set or installed. In this case, the controller 1 has a learning function, and the controller 1 updates the database 4 to adjust the level of the proper condition according to usage of a user. Alternatively, the above preliminary input system and the above preliminary install system are combined, so that the database 4 may be established according to the driving condition of the driver. Alternatively, the data of the proper condition level may be improved to have high accuracy when the time zone, the navigation information and the traffic amount are considered and/or when the driving situation is considered deeply.

In the above case, when the learning function of the controller 1 is performed, for example, as shown in FIG. 6, the proper condition of each item for a standard driver at different situation may be preliminarily stored in the database 4. Here, for example, the standard level of the inattentive driving on the highway is defined as Lv1, and the standard level of the drowsiness state on the highway is defined as Lv2. The standard level of the inattentive driving at the intersection is defined as Lv3, and the standard level of the drowsiness state at the intersection is defined as Lv1.

The item for the proper condition level of the standard driver includes “the fatigued state” and “the strained state” in addition to “the drowsiness state” and “the inattentive driving state.” Alternatively, a combination of these items may be input as a learning factor.

An example of updating the database 4, i.e., an example of improving the accuracy of the data of the proper condition for each driver by the learning function is described below.

(1) When the driving support device detects the driving condition of the driver A, and determines that the inattentive driving level is defined as Lv3, the driving support device obtains a vehicle-to-vehicle distance between the subject vehicle and a forward vehicle in front of the subject vehicle based on an image of a camera for shooting the front side of the subject vehicle. When the vehicle-to-vehicle distance is not equal to or less than a threshold distance, the device determines that the driver A visually recognizes the surroundings of the vehicle, and the device learns that the inattentive driving level of Lv3 is the proper condition of the driver A.

(2) When the vehicle travels on the school route in the commuting time zone, the driver needs to visually recognize the surroundings of the vehicle frequently. Thus, even when the driving support device detects the driving condition of the driver, and determines that the inattentive driving level is defined as Lv4, the controller 1 learns that the proper driving condition for the driver under this situation is the inattentive driving level of Lv4 since, in view of this condition which the vehicle runs through the school route in the commuting time zone, the controller 1 determines that the driver frequently and visually recognizes the periphery of the vehicle.

(3) When the driver feels sleepy, some drivers may reduce the sleepiness by shaking the head of the driver intentionally. Thus, even when the driving support device detects the driving condition of the driver, and determines that the inattentive driving level is defined as Lv4 in a case where the drowsiness level is Lv3 at the same time, the controller 1 learns that the proper driving condition for the driver under a condition, which the drowsiness level is Lv3, is the inattentive driving level of Lv4 since the controller 1 determines the driver intentionally shakes the head of the driver in order to reduce the sleepiness. This is an example where the driving support device considers multiple factors of the proper driving condition comprehensively, and sets the level of the proper driving condition for the driver according to the driving situation.

(4) When the driving support device executes the notification operation based on the data of the level indicative of the proper condition for the driver at a certain situation, which is registered in the database 4, the driver may question the notification operation. For example, when the displacement range of the visible line is expanded since the driver visually recognizes the surroundings of the vehicle carefully in a case where it is necessary to pay much attention to the surroundings, the device may determine that the driver is in the inattentive driving state so that the device notify the inattentive driving of the driver.

In the above case, the driver may input via an input operation switch equipped in the navigation device or the like that the notification operation is not appropriate. As a result, the device executes the notification operation with high accuracy, and therefore, the device restricts the unnecessary notification operation when the driver drives the vehicle normally and properly.

In the above embodiment, the data indicative of the level of the proper driving condition for each driver at each situation is stored in the database 4. Thus, the controller 1 compares the detected driving condition of the deriver with the proper driving condition for the driver at that situation, and determines whether the detected driving condition is the proper condition. Thus, the device executes the notification operation properly to the driver, and therefore, the driver does not feel uncomfortable with the notification operation so that the device facilitates the recovery to the proper driving condition.

The controller 1 having the learning function updates the data of the proper driving condition level for each driver at each situation stored in the database 4. Even when the driving manner of the driver is changed, the device determines the proper driving condition with high accuracy since the controller 1 updates the data according to the change of the driving manner.

### Other Embodiments

In the above embodiment, the notification device 3 includes the display 3a and the voice output device 3b. The device may execute the notification operation using only one of the display 3a and the voice output device 3b. Alternatively, the device may use both of the display 3a and the voice output device 3b. Alternatively, the device may execute the notification operation using tactile impression operation such that the device changes the wind from the air conditioner, or changes the temperature of the seat heater or the steering wheel heater. Alternatively, the device may execute the notification operation using sensuous impression operation such that the device changes the lighting manner of the LED (light emitting diode).

In addition to the navigation device, the device may obtain the traffic information from an external system, so that the device detects the driving condition and/or determines the proper driving condition.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driving support device for a vehicle comprising:
a detector that detects a driving condition of a driver;
a memory that stores a proper driving condition of the driver; and
a controller that compares a detected driving condition with the proper driving condition stored in the memory, calculates a difference between the detected driving condition and the proper driving condition, and executes a notification operation to the driver according to the difference when the controller recognizes the difference.

2. The driving support device according to claim 1, wherein:
the detector obtains information of a driving situation;
the memory stores the proper driving condition in accordance with the driving situation; and
the controller compares the detected driving condition with the proper driving condition corresponding to the driving situation, and calculates the difference between the detected driving condition and the proper driving condition corresponding to the driving situation.

3. The driving support device according to claim 1, further comprising:
a driver identifier that identifies the driver when a plurality of drivers drives the vehicle; wherein:
the controller compares the detected driving condition with the proper driving condition corresponding to an identified driver, and calculates the difference between the detected driving condition and the proper driving condition corresponding to the identified driver.

4. The driving support device according to claim 1, wherein:
the controller accumulates information about the detected driving condition and the difference; and
the controller updates the proper driving condition of the driver stored in the memory according to accumulated information.

5. The driving support device according to claim 1, wherein:
the detector includes a camera for shooting the driver and a sensor for detecting a driver condition.

6. The driving support device according to claim 1, wherein:
the detector obtains information of a driving situation according to information from a vehicular navigation device.
